(19) United States
(12) Patent Application Publication
(10) Pub. No.: US 2005/0082137 A1
(43) Pub. Date: Apr. 21, 2005

(54) Modular ultrasonic clutch brake mechanism

(76) Inventor: Kuo-Tsi Chang, Mialoli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/686,651

(22) Filed: Oct. 17, 2003

(51) Int. Cl. F16D 28/00

(52) U.S. Cl. 192/84.1

(57) ABSTRACT

The modular ultrasonic clutch brake mechanism comprises an AC power control unit, a driving member, a driven member, two supporting frame units, a pre-loaded force adjustment means, two connectors, and a pedestal. Both the driving and the driven members are made of a piezoelectric substance. Then, contact surfaces of the two members are forcibly coupled and trammeled using a clutching force existing between the contact surfaces when both the two members are not energized. This clutch effect is released by energizing the piezoelectric substance with AC power for inducing an ultrasonic vibration on the piezoelectric device. Thus, contact surfaces of the two members are separated using the ultrasonic vibration of each member energized when at least one of the two members is energized. Moreover, a frication brake means may be fixed on the contact surface of each of the two members to ensure the reliability of the mentioned mechanism.

### BACKGROUND OF THE INVENTION

1. Field of the Invention

The present invention relates to a modular ultrasonic clutch brake mechanism which utilizes the inverse-piezoelectric effect in a piezoelectric element so as to connect or disconnect a driving member and a driven member thereby performing start, stop or speed change of the invented mechanism controlled according to operator's requirements.

2. Description of the Prior Art

Many types of conventional clutch brake mechanisms are available in clutch and brake markets either manually operated or automatically operated for performing start, stop, direction control, speed change, connection or disconnection between a driving shaft and a driven shaft for a machine. However, each type of conventional clutch and brake mechanisms has its inherent shortcomings, namely:
1. Mesh-in type: Protrusions such as gear teeth or keys are provided for both driving and driven members for meshing with each other to transmit torques. Before meshing, the difference of rotational speeds between the two members can not be too large to avoid excessive impact which probabley damages the mechanism.
2. Friction type: Above two members are coupled with a sufficient frictional force which enables the driving member to drive the following member conveniently and reliably. The coupling and separation can be carried out promptly with small impact force and vibration. Unfortunately, an abrasive slip between the two coupled members caused by a heavy load shortens the durability of the mechanism and calls for a frequent replacement or adjustment of the spare parts.
3. Magnetic powder type: An exciting coil is used to magnetize some of magnetic powder to generate magnetic flux linkages which transmits a driving torque at a driving shaft to a following shaft. Meanwhile, the driving torque is approximately proportional to the intensity of the magnetic field and the exciting electric current as well. This magnetic powder clutch is used to drive the two coupled members in the same speed, or under controllable speed difference. Thereby, overload protection is assured by slipping of the magnetic powder, and speed regulation with smooth and stepless is controlled by the exciting current. Unfortunately, this magnetic powder type causes severe electromagnetic interference.
4. Overtaking type: Ratchet wheels, ratchet pawls, rotary cylinders, or wedge blocks are used to transmit the motion and torque in one direction. In spite of its simple construction, a considerably bulky size and a loud noise arising at the moment of separating two coupled members restrict this type of mechanism can only applicable for low speed and non-precision machines.

In view of the present situation that there has been no any electrically controlled clutch and brake mechanisms which can precisely adjust the driving torque in response to the variation of the load torque and can be available on the market, it is why the inventor of the present invention has endeavored for years by continuous research and experimentation attempting to find out a new product to overcome the inherent shortcomings of the conventional products described above, and finally succeeded in creating the present invention.

### SUMMARY OF THE INVENTION

Accordingly, it is an object of the present invention to provide a modular ultrasonic clutch brake mechanism which utilizes a friction force produced by an activated piezoelectric element contained in a driving member connected to a motor shaft and a driven member connected to a load shaft or both the members to convert the driving torque at the motor shaft to the load shaft.

It is another object of the present invention to control the output torque at the motor side to the load side by the aforesaid frictional force produced between contact surfaces of the driving and the driven members controlled electrically.

It is still another object of the present invention that an electrical control manner for the mechanical torque can be carried out without causing an electromagnetic interference.

It is still another object of the present invention that the above adjustable frictional force produced between the contact surfaces of the above two members can be obtained by adjusting the value of a pre-loaded force applied to the above two members by an adjustable pre-loaded force controlled using a supporting frame in the mechanism.

To achieve the objects mentioned above, the modular ultrasonic clutch brake mechanism according to the present invention comprises an AC power control unit, a driving member, a driven member, two supporting frame units, a pre-loaded force adjustment means, and a pedestal.

The AC power control unit further includes an AC power supply for supplying the AC power to the piezoelectric element in the driving or driven member via a carbon brush set to be illustrated later; a control switch for controlling the supplied AC power in the piezoelectric element; two slip rings for guiding the supplied AC power to the piezoelectric element through electric conductors; a carbon brush set comprising carbon brushes and a brush holder for connecting the supplied AC power to the slip rings.

The coupling between the driving member and the driven member may be disconnected using mechanical vibration produced by the inverse-piezoelectric effect. The driving member can be an ultrasonic vibrator or a piezoelectric resonator with piezoelectric material. The ultrasonic vibrator comprises a pair of adjoining piezoelectric elements, two non-adjoining cylindrical metal blocks; and two slip rings. Both the metal blocks are mutually engaged using a threaded screw with its associated nut. The piezoelectric resonator comprises a piezoelectric element, a metal block, and a slip ring.

The driven member for keeping a non-contacting state with the driving member can be an ultrasonic vibrator, a piezoelectric resonator, a piezoelectric substance, and a metal disc or a hard non-metallic plate.

A confinement means is a combination of a tenon and mortise joint, a stud tenon is provided on the contact surface of the driven member, while a slot mortise is provided on the contact surface of the driving member so as to trammel the stud tenon of the driven member thereinto.

The invented clutch brake mechanism comprises two supporting frame units and others. Each supporting frame unit includes a supporting frame for supporting a bearing appropriately along the center line of the shaft of the invented mechanism, a bearing for supporting the driving member or the driven member, and a spring washer for providing a resilient pre-loaded force to the contact surfaces of the two members.

The pre-loaded force adjustment means installed at the center of the supporting frame to couple with its inner threaded hole is used for adjusting the frictional force between the contact surfaces of the driving and the driven members.

Finally, the supporting frame units are mounted and fixed on a pedestal.

### BRIEF DESCRIPTION OF THE DRAWINGS

The above objects and other advantages of the present invention will become more apparent by describing in detail the preferred embodiment of the present invention with reference to the attached drawings, and in the attached drawings, the elements which have substantially same constitutions and functions will be assigned with the same reference codes in which:

FIG. 1(a)—1(c) are drawings illustrating the schematic view and operational principle of the present invention with a diagram of the piezoelectric effect.

FIG. 2(a)˜2(b) are three dimensional exploded views, and FIG. 2(c)˜2(d) are assembly views, of the present invention.

FIG. 3 includes a three dimensional exploded view of the clutch mechanism of the present invention associated with a pre-loaded force adjustment means (FIG. 3(a)), and the assembly views thereof (FIG. 3(b), 3(c)).

FIG. 4 includes a three dimensional exploded view of the driven member associated with a metal disc or a piezoelectric element (FIG. 4(a)), and the assembly views thereof. (FIG. 4(b), 4(c)).

FIG. 5 includes a three dimensional exploded view showing a frictional disk is provided on the contact surface of the driving or the driven member (FIG. 5a), and the assembly views thereof (FIG. 5(b), 5(c)).

FIG. 6 includes a three dimensional exploded view showing a frictional disk is provided on the contact surface of the driving member, and the driven member is associated with a metal disc or a piezoelectric element (FIG. 6(a)), and the assembly views thereof (FIG. 6(b), 6(c)).

FIG. 7(a)˜7(b) are the schematic views showing the operational principle of the clutch mechanism of the present invention.

FIG. 8 includes a three dimensional exploded view showing the driven member is provided with a frictional brake disk while the driving member is mounted on the supporting frame fixed on a pedestal (FIG. 8(a)), and the assembly views thereof (FIG. 8(b), 8(c)).

FIG. 9 includes a three dimensional exploded view showing the driven member is provided with a pre-loaded force adjustment means and a frictional brake disk serving as a braking device for the machine while the driving member is mounted on the supporting frame fixed on a pedestal (FIG. 9(a)), and the assembly views thereof (FIG. 9(b), 9(c)).

FIG. 10(a)˜10(b) are illustrative views showing the braking operation of the brake mechanism of the present invention; and

FIG. 11(a)˜11(b) are schematic views showing a confinement means and illustrating operation thereof according to the present invention for making the center line of the shaft of the machine along a straight line.

### DETAILED DESCRIPTION OF THE PREFERRED EMBODIMENT

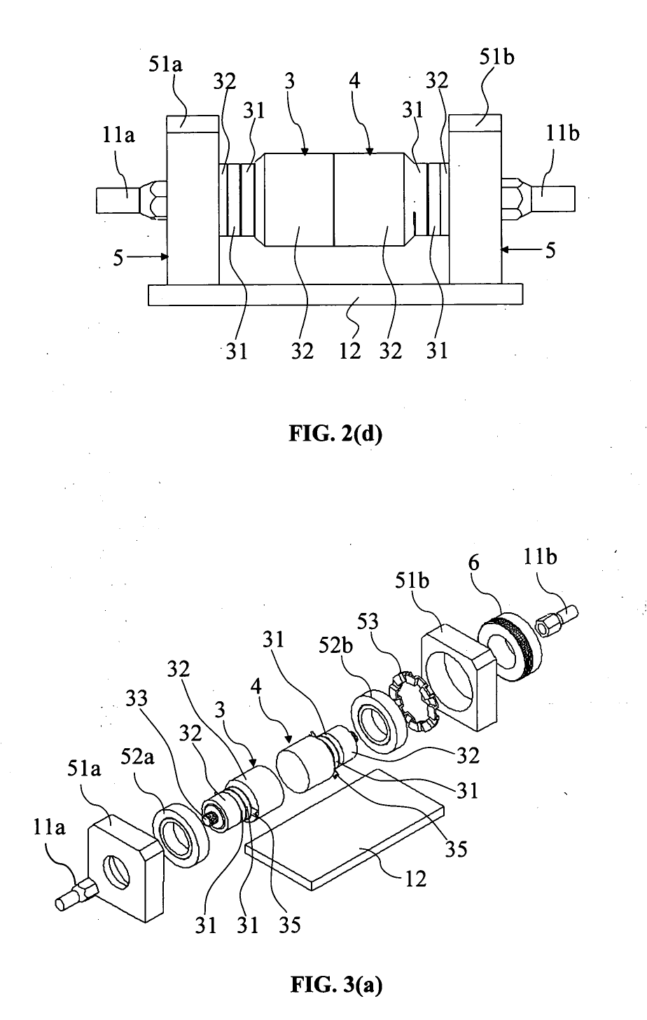

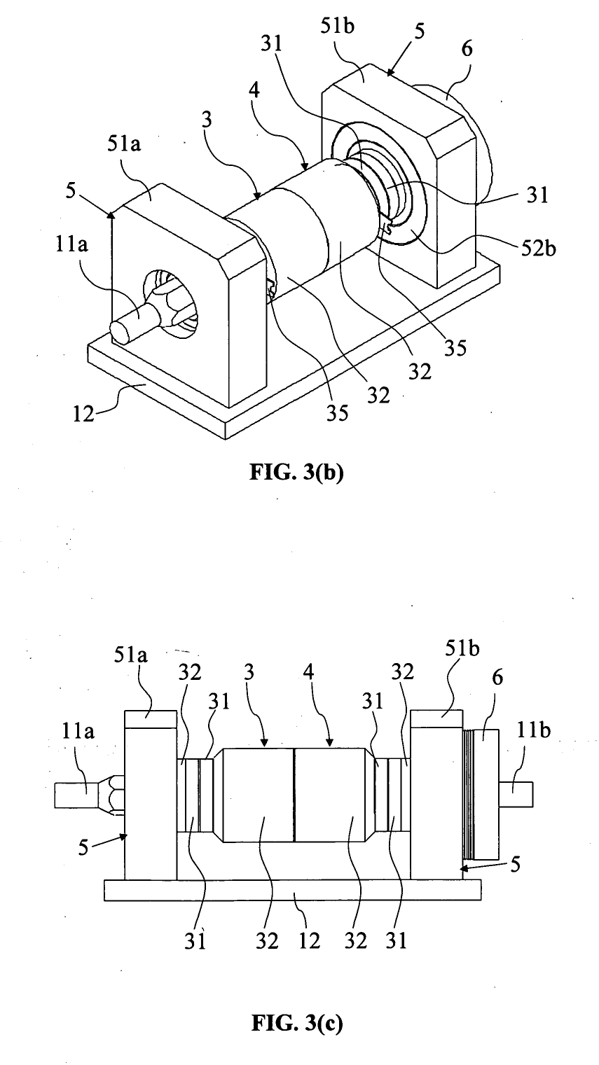

For understanding the construction of the present invention, referring to FIGS. 3(a) through 3(c) where the essential components which have substantially same constitutions and functions are disposed oppositely along a straight line. The present invention essentially comprises an AC power control unit, a driving member 3, a driven member 4, two supporting frame unit 5, a pre-loaded force adjustment means 6, two inner-threaded connectors 11a, 11b, and a pedestal 12 for entraining the aforementioned components.

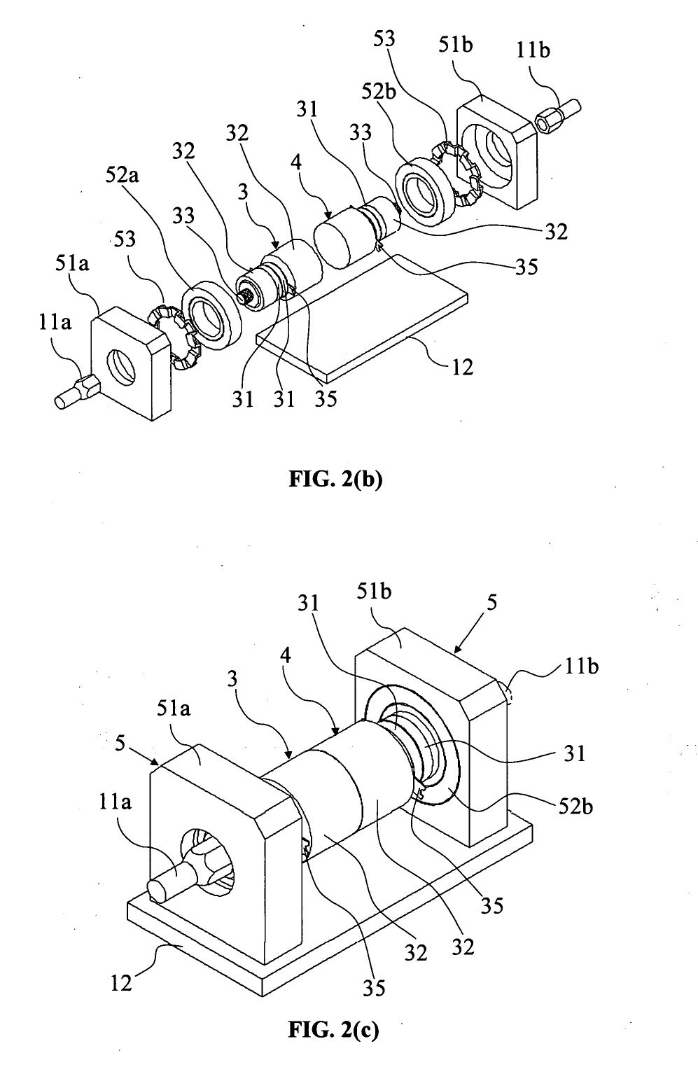

Further referring to FIGS. 2(a) through 2(d) together with FIGS. 3(a) through 3(c), it can be obvious that the clutch mechanism of the present invention is fixed on the pedestal 12, and the two supporting frame units 5 combines with the pedestal 12 using screws. Next, the shaft of the driving member 3 is inserted into the hollow cavity of a bearing provided for the left supporting frame 51a, and the shaft of the driven member 4 is inserted into the hollow cavity of a bearing provided for the right supporting frame 51b. Then, the supported terminals of the driving and the driven members 3, 4 are screw combined with the connectors 11a, 11b respectively, where one of the connector 11a or 11b is applied to connect the driving member 3 or the driven member 4 to a rotating terminal.

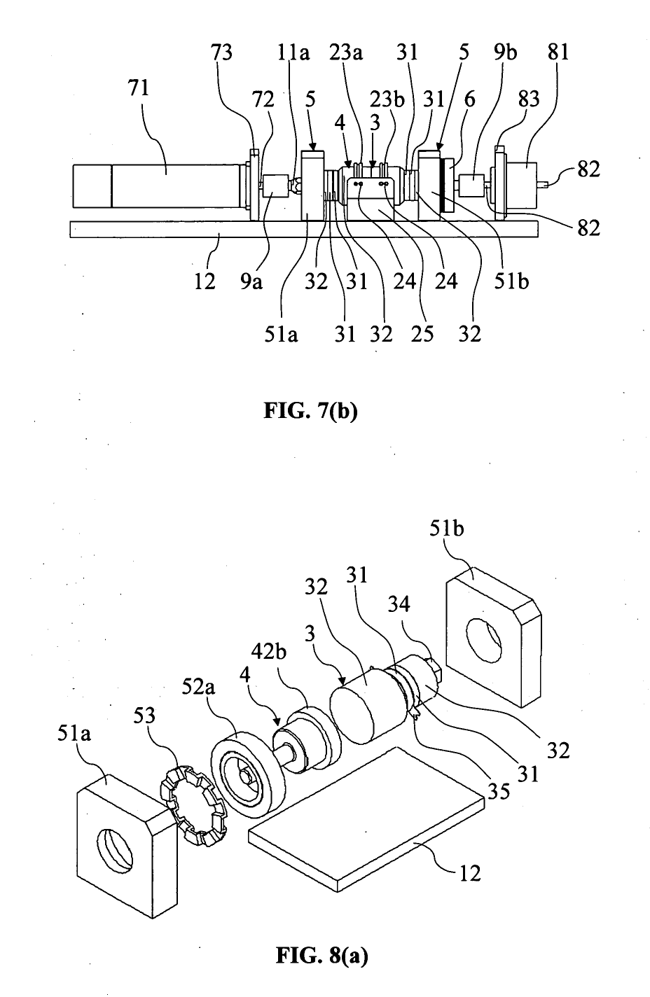

Referring to FIGS. 7(a) and 7(b) for understanding the operational principle of the present invention, It can be observed that the driving member 3 is conjoined with a motor shaft 72 using the connector 11a and a coupler 9a. On the other band, the driven member 4 is conjoined with a load shaft 82 using the connector 11b and another coupler 9b.

Again referring to FIGS. 3(a) through 3(c) for understanding the structure of the present invention, wherein a spring washer 53 and the pre-loaded force adjustment means 6 are shown. The pre-loaded force adjustment means 6 with outer threaded surface can be coaxially inserted into a hole of the supporting frame 51b with inner-threaded surface for mutual screw engagement. With this structure, the spring washer 53 is interposed between the supporting frame 51b and a bearing 52b which snugly couples with the supporting frame 51b by its outer edge. In this manner the frictional force on the contact surfaces of the driving member 3 and the driven member 4 is controllable by the pre-loaded force adjustment means 6.

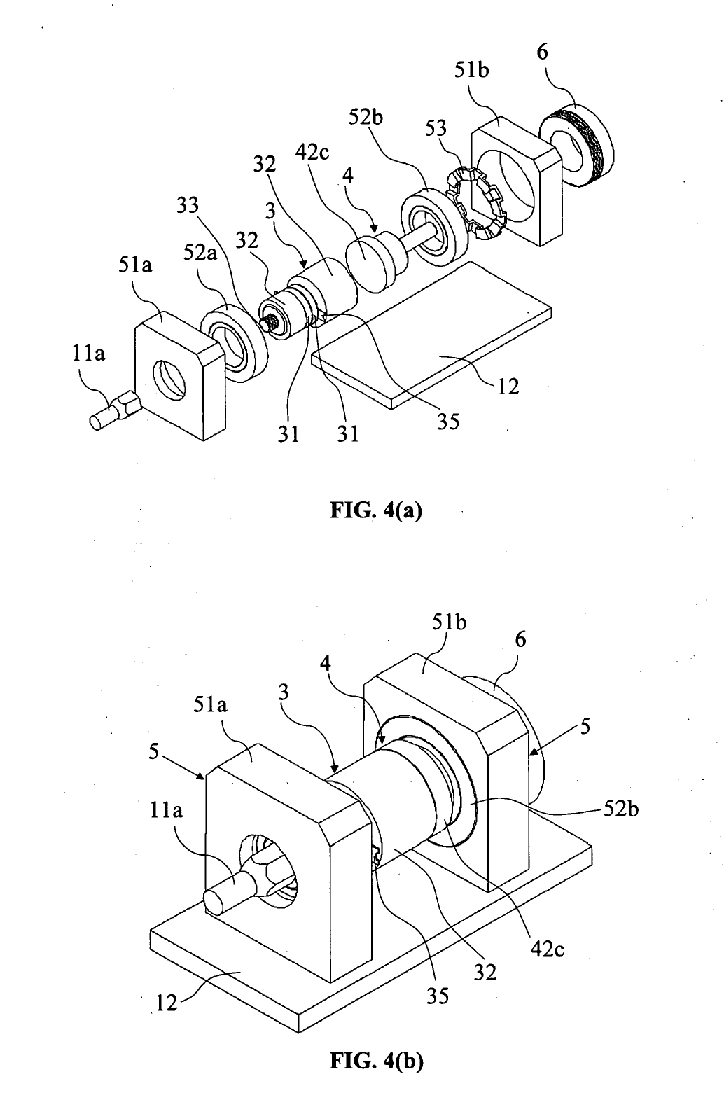

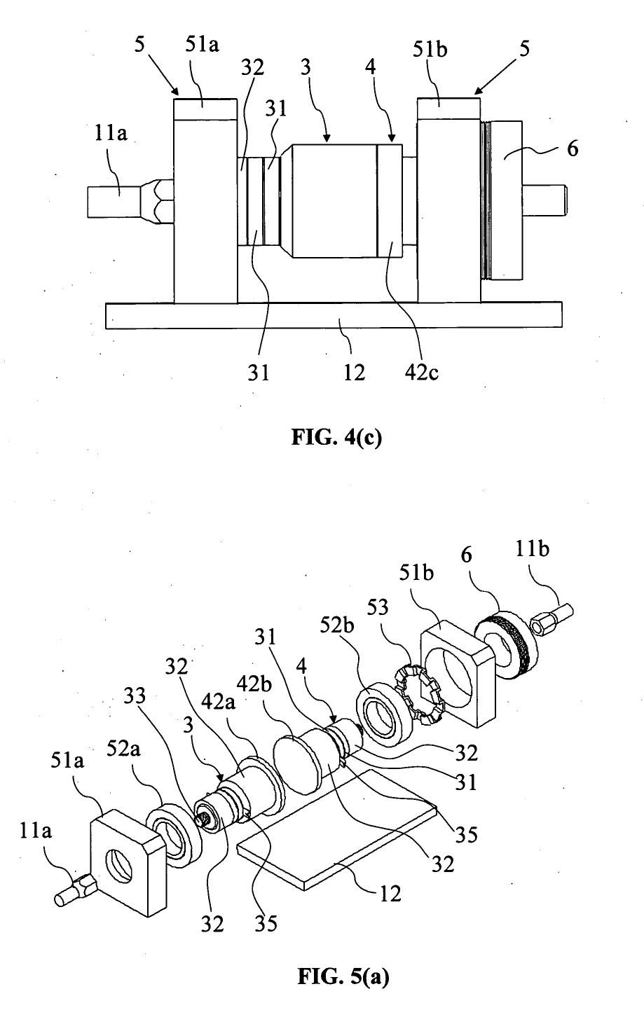

Referring to FIGS. 4(a) through 4(c), it can be observed that the driving member 3 includes a pair of adjoining piezoelectric elements 31, two non-adjoining cylindrical metal blocks 32, and a outer-threaded bolt 33, wherein the piezoelectric element 31 and the metal block 32 are fastened together by the outer-threaded bolt 33 and a inner-threaded connector 11a. On the other hand, the driven member 4 includes a metal disc 42c or a piezoelectric element 31 so as to couple the driving member 3 and the following member 4 together or make the driven member 4 to separate from the driving member 3. Then, the driving member 3 is conjoined with the driving shaft 72 through the connector 11a, and the driven member 4 is conjoined with the load shaft 82 through the connector 11b, according to FIGS. 7(a) and 7(b).

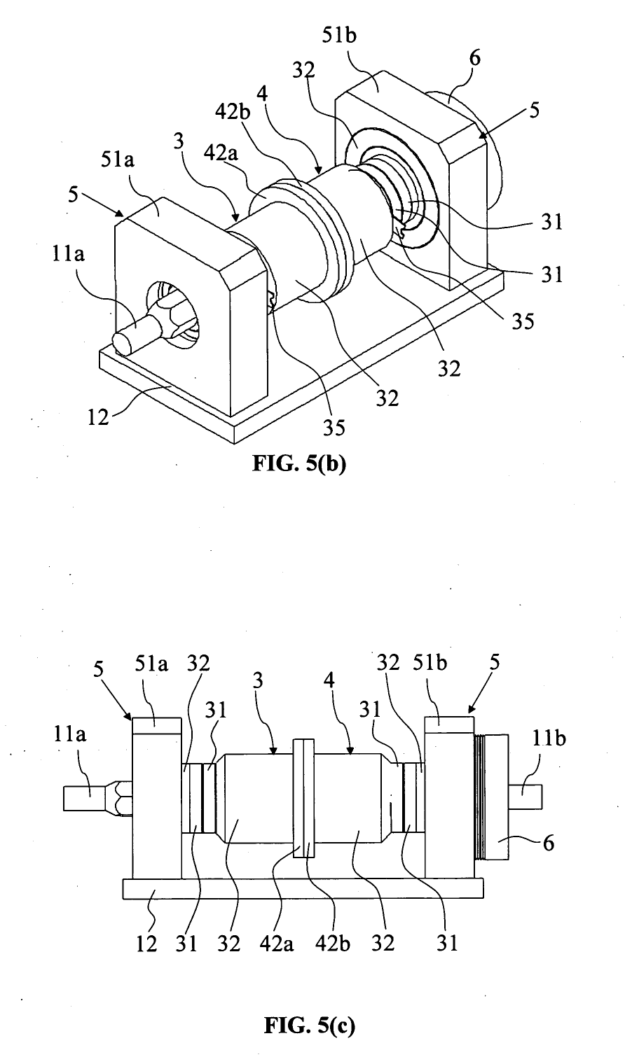

Referring to FIGS. 5(a) through 5(c), each of both driving and driven members 3, 4 include a pair of piezoelectric elements 31, two non-adjoining cylindrical metal blocks 32, and a outer-threaded bolt 33, wherein the piezoelectric element 31 and metal block 32 are fastened together by the outer-threaded bolt 33 and a inner-threaded connector 11a or 11b. Meanwhile, a planar frictional disk 42a or 42b is intercalated and fixed on each contact surface of the two members 3, 4. However, FIG. 5(a) shows a three dimensional exploded view, and FIGS. 5(b) and 5(c) are the assembly views thereof.

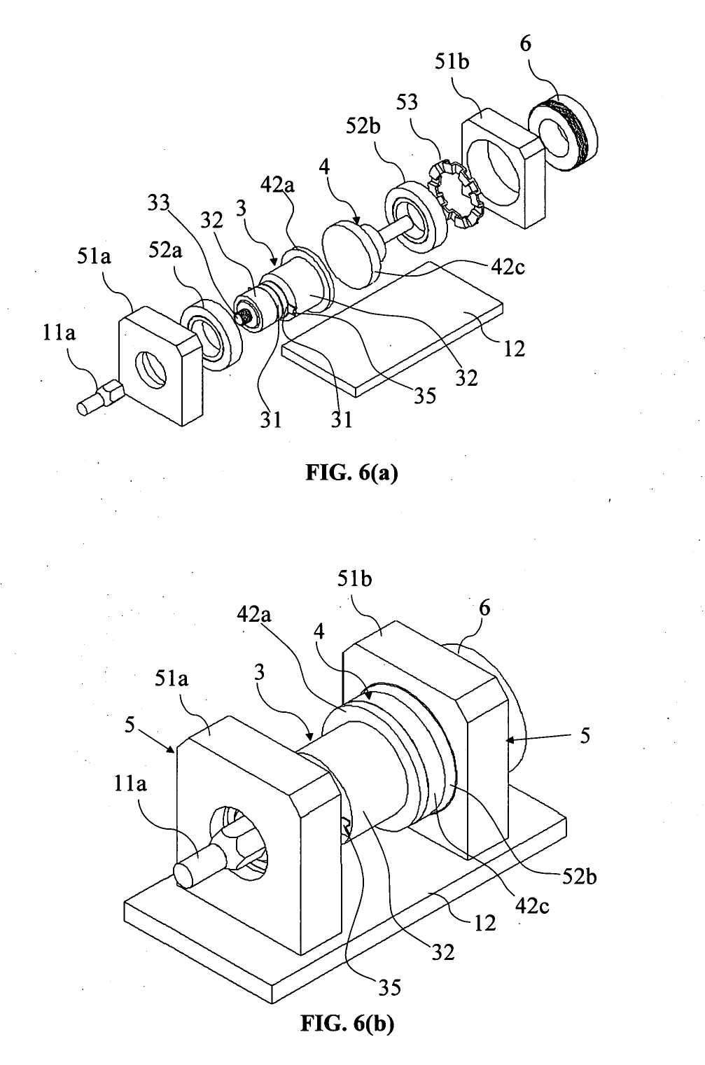

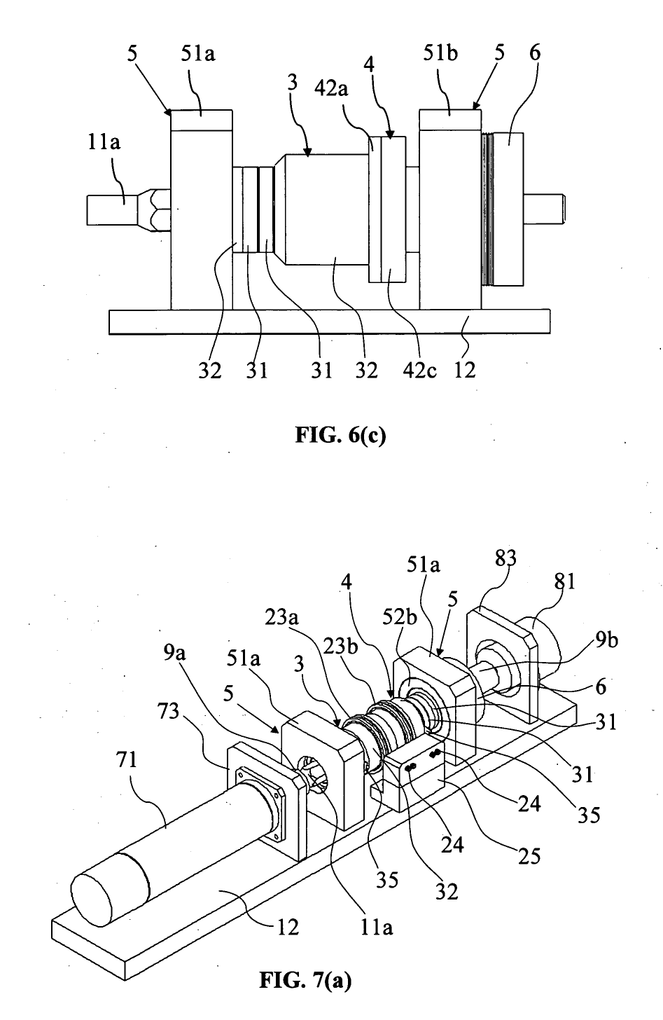

Referring to FIGS. 6(a) through 6(c), in this embodiment, the driving member 3 provided with a frictional disk 42a and the driven member 4 provided with a metal disc 42c or a piezoelectric element 31 can be used to perform the clutching action of the present invention by the joint or separation of the two members 3 and 4.

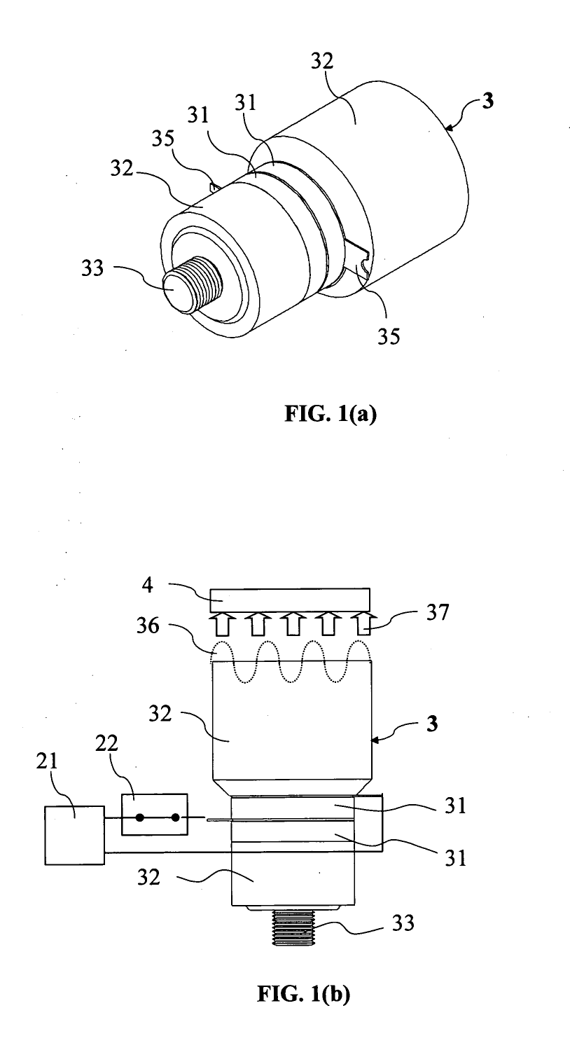

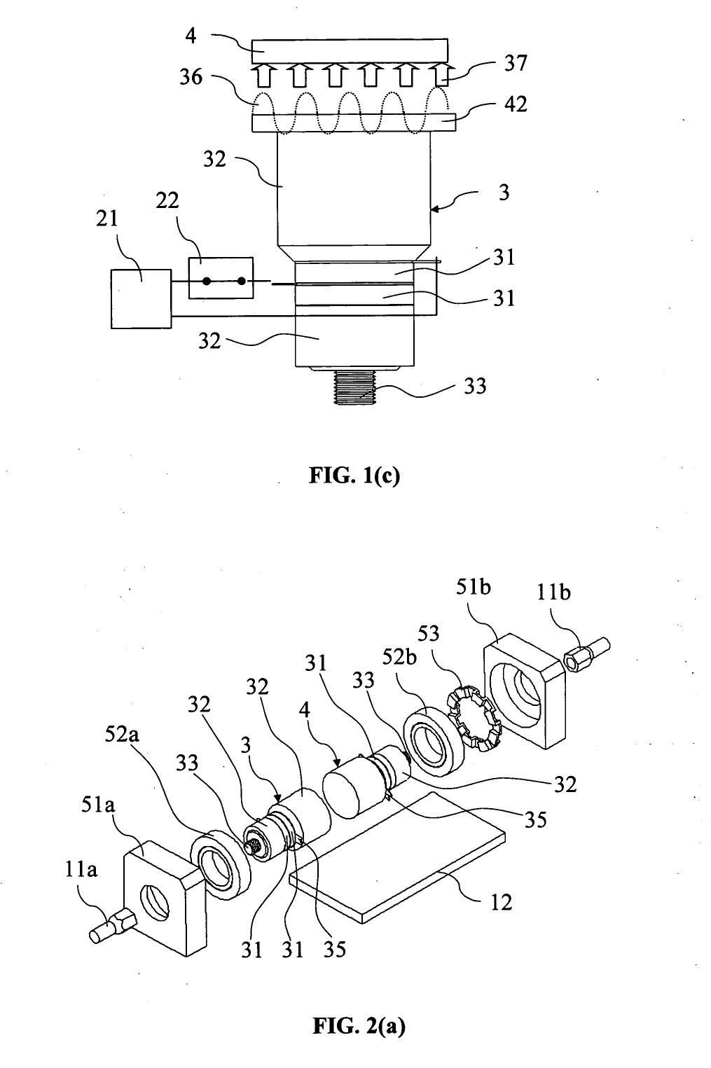

Referring to FIGS. 1(b) and 1(c) together with FIGS. 7(a) and 7(b) for understanding the performance of the AC power control unit of the present invention. This AC power control unit includes an AC power supply 21 for introducing the power supply to a carbon brush holder 25 to be explained later; a control switch for controlling the condition of the power supply 21 to the piezoelectric element 31; two slip rings 23a, 23b each configured in an annular ring for the piezoelectric element 31 to pierce through their inner holes so as to introduce the AC power to the piezoelectric element 31 with associated electric conductors; four carbon brushes 24; and a carbon brush holder 25 for connecting the power supply to the slip rings 23a, 23b.

For understanding the performance of the present invention more clearly, according to FIGS. 7(a) through 7(b), the clutch brake mechanism of the present invention may be interposed between a motor unit 71 and a load unit depending on the decision of the user. Then, the motor unit is conjoined with the connector 11a at the driving member 3 side through a coupler 9a, and the load unit is conjoined with the connector 11b at the driven member 4 side through a coupler 9b. The motor unit includes a motor 71, a motor shaft 72, and a motor support 73. The load unit has a load 81, a load shaft 82, and a load support 83. As soon as the motor 71 has been energized, the driving member 3 simultaneously rotates with the motor shaft 72. Then, the driving member 3 is forcibly coupled with the driven member 4 as both the members are not energized. At this moment, the load shaft can simultaneously rotate with the motor shaft. Moreover, the driving member 3 is separated from the driven member 4, and thus the driving member 3 and the load shaft are stationary as at least one of both the members is energized.

Next, the AC power generated from the AC power supply 21 via the control switch 22 is supplied to the piezoelectric element 31 of the driving and the driven members 3, 4, wherein the control switch 22 governs the ON/OFF state of the AC power. At this moment, when the control switch 22 is operated at the ON state, the AC power can be supplied to the slip rings 23a, 23b belonging to the two members 3, 4 respectively so as to energize the piezoelectric element 31 thereby causing it to induce a inverse piezoelectric effect which makes the metal block 32 to produce a mechanical vibration 36. Meanwhile, a radiation field 37 built up by the mechanical vibrator 36 can release the clutching action between the two members 3, 4 such that the contact surfaces of the two members 3, 4 thereof will be separated. On the contrary, when the control switch 22 is operated at the OFF state, the radiation field 37 can not be built up since it loses the AC power supplied to the piezoelectric element 31. Hence, the aforesaid two contact surfaces are forcibly coupled with each other to transmit the driving torque at the motor unit to the load unit.

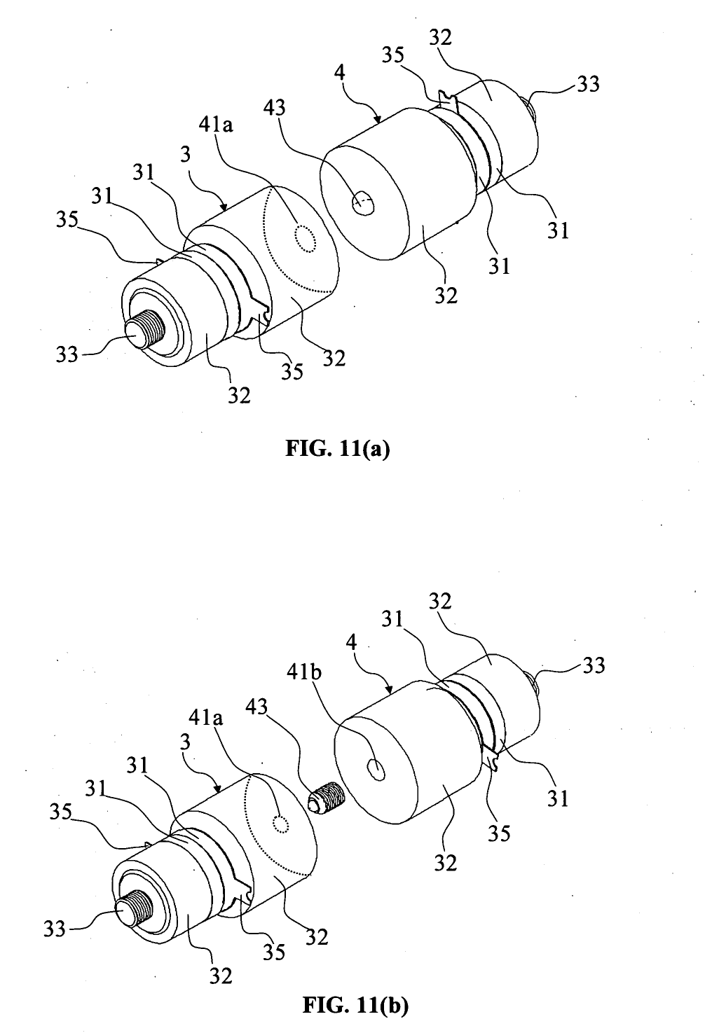

For understanding the performance of the confinement means provided for the present invention, referring to FIG. 11(a), the confinement means is formed of a tenon and mortise joint, wherein a stud tenon 43 is provided on the contact surface of the driven member 4, and a slot mortise 41a is provided on the contact surface of the driving member 3 so as to trammel the stud tenon 43 of the driven member 4 thereinto. The confinement means severs to prevent offset of the shaft center between the separated driving and the driven members 3, 4 when they come to re-couple with each other. Next, referring to FIG. 11(b), an outer-threaded screw with a stud tenon 43 may be fixed in the center hole of the contact surface of the driven member 4, and thus the stud tenon 43, is provided on the inner surface of the slot mortise 41b at the center of the contact surface of the driving member 3 so as to ensure reliability of the engagement between the two members 3 and 4. And, a ball serving as the stud tenon 43 can also be provided on the tip of the outer-threaded screw to be trammeled into the slot mortise 41a. Alternatively, the stud tenon 43 can be provided on the center of the contact surface of the driving member 3, and the slot mortise 41b can be provided on the center of the contact surface of the driven member 4.

It should be noted that the driving member 3 and the driven member 4 are substitutional for each other in the case one of them is provided with the piezoelectric element 31, and the other one has a metal plate as a contact element. In both cases, the control switch 22 can serve to apply the AC power to the piezoelectric element 31 which builds up the radiation field 37 thereby producing a clutching effect between the driving and the driven elements 3 and 4.

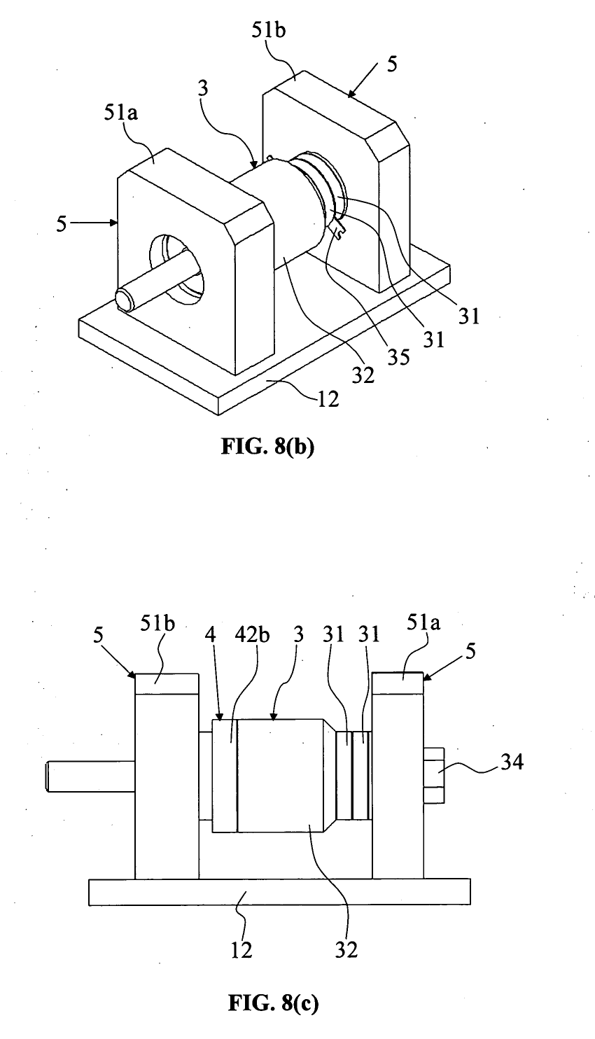

Regarding the brake mechanism of the present invention, referring to FIGS. 8(a) through 8(c), it can be seen that the driven member 4 is provided with a frictional brake 42b for braking operations. This friction brake 4 is normally closed. In this braking case, the driving member 3 can be made of an ultrasonic vibrator, a piezoelectric resonator, or any piezoelectric element. The ultrasonic vibrator is formed of a pair of adjoining piezoelectric elements 31 tightly fastened to two non-adjoining cylindrical metal blocks 32 using an outer-threaded bolt 33 associated with a nut 34. The piezoelectric resonator is formed of a piezoelectric element 31 and a metal dsic 32. Before the driving member 3 is energized, the contact surfaces of the driving element 3 and the friction brake 42b are forcibly coupled with each other. Then, separating the driving element 3 from the friction brake 42b is carried out after energizing the piezoelectric element 31 in the driving member 3.

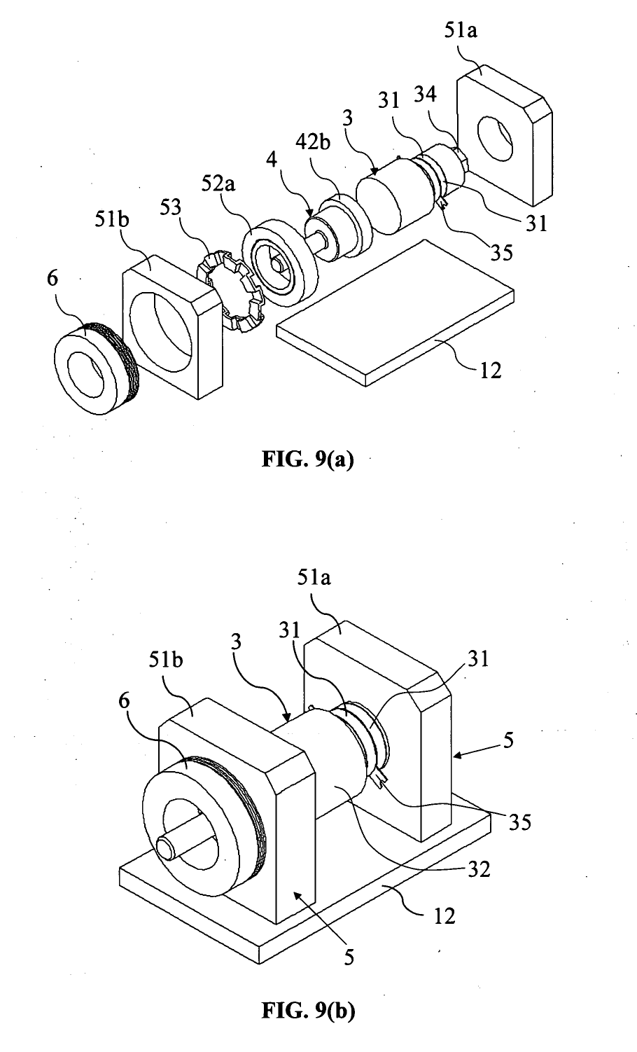

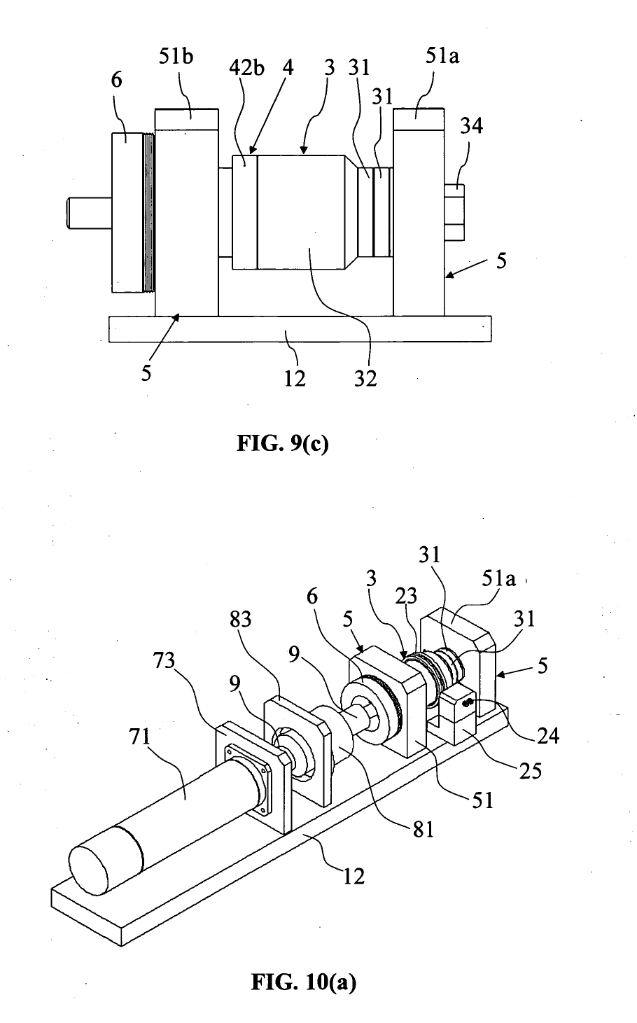

As shown in FIGS. 9(a) through 9(c), a pre-loaded force adjustment means 6 is added to adjust the strength of friction force between the contact surfaces of the driving member 3 and the frictional brake 42b.

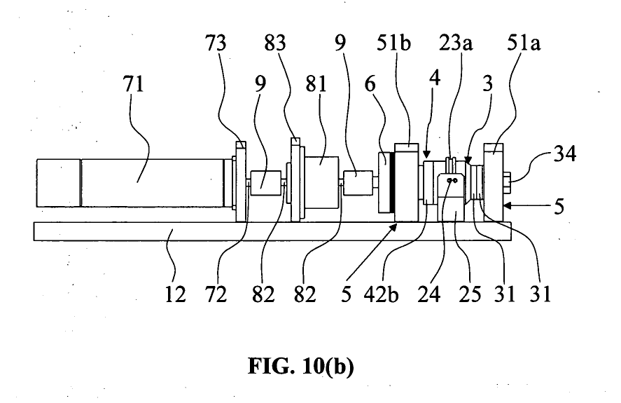

For understanding the braking operation of the present invention, referring to FIGS. 10(a) and 10(b), the driving member 3 is fastened to the supporting frame 51a, and the friction brake 42b is engaged with the motor shaft 72, wherein the supporting frame 51a fixed on the pedestal 12 is stationary. Before the driving member 3 is energized, the contact surfaces of the driving member 3 and the friction brake 42b are tightly contacted with each other so that the friction brake 42b can not rotate by a braking effect. On the other hand, after the driving member 3 is energized, the contact force between the driving member 3 and the friction brake 42b will be released such that the friction brake 42b loses its braking effect and rotates with the motor shaft 72 simultaneously. Alternatively, the components of the driving member 3 and the friction brake 42b can be substituted for each other. That means the driving member 3 can also be connected to the motor shaft, and a friction brake can be fixed on the supporting frame. This driving member is made of the ultrasonic vibrator, the piezoelectric resonator, or any piezoelectric element mentioned above. However, the driving member 3 or the driven member 4 contains the piezoelectric element 31, and the corresponding coupled element contains a metallic member for inducing the braking effect by the controlled AC power supplied to the piezoelectric element 31. Additionally, the driving member 3 can also be employed to serve as a brake means for controlling rotational motion or linear motion.

It emerges from the above descriptions that the present invention has the following noteworthy advantages compared with the conventional techniques, namely:

1. That the modular structure of the present invention can facilitate the assembly work, and the associated pre-loaded force adjustment means can finely and easily adjust the clutching force of the invention mechanism.

2. That a strong mechanical vibration induced on the contact surfaces of the driving and the following members after energizing the piezoelectric element in the driving or the following member can reliably release the clutching operation between the driving and the following members;

Although the description above merely provides illustrations of some of the presently preferred embodiments of this invention, it should not be construed for limiting the scope of the invention. Thus the scope of the invention should be determined by the appended claims and their legal equivalents, rather than by the examples given.

1. A modular ultrasonic clutch mechanism comprising:
an AC power control unit including an AC power supply for supplying AC power to a piezoelectric element with electric conductors via carbon brushes; a control switch for controlling the connection or disconnection between the AC power supply and the carbon brushes; two slip rings for introducing the AC power to said piezoelectric element; four carbon brushes; and a brush holder for connecting the supplied AC power to said slip rings;
a driving member being a ultrasonic vibrator for generating a mechanical vibration, and being able to disconnect the clutching operation between the driving and the driven members by a radiation field induced using the mechanical vibration; said driven member being a ultrasonic vibrator for providing means to keep a non-contacting state with said driving member;
two supporting frame units, wherein each of them contains a supporting frame for supporting a bearing appropriately along the center line of the mechanism; said bearing for supporting the shaft of said driving and said following members; and a spring washer equipped between said supporting frame and said bearing for providing a pre-loaded force;
two connectors for connecting said driving and said driven members to the rotating terminal of said mechanism; and
a pedestal for mounting said supporting frame units.
as said driving member is energized by an AC power supply, a vibration occurs on its surface thereof which includes a radiation pressure field that causes the contact surfaces of said driving member and said driven member to be separate and no braking effect is produced; the braking effect is produced, and the contact surfaces of said driving member and said driven member are coupled by tight contact between said two surfaces when at least one of said driving member and said driven member is not energized by an AC power supply.

2. The clutch mechanism as in claim 1, wherein said ultrasonic vibrator is formed of a pair of adjoining piezoelectric elements, two non-adjoining cylindrical metal blocks, and two slip rings, and the above components are tightly connected by a threaded bolt and a nut.

3. The clutch mechanism as in claim 1, wherein said driving member or said driven member is a piezoelectric resonator.

4. The clutch mechanism as in claim 3, wherein said piezoelectric resonator is formed of a piezoelectric element, a metal bock, and a slip ring.

5. The clutch mechanism as in claim 1, wherein said driving member or said driven member is made of a piezoelectric substance.

6. The clutch mechanism as in claim 1, wherein said driven member is a metal disc.

7. The clutch mechanism as in claim 1, wherein said driven member is a rigid non-metallic plate.

8. The clutch mechanism as in claim 1, wherein said supporting frame has an inner-threaded hole to fasten a pre-loaded force adjustment means.

9. The clutch mechanism as in claim 1, wherein the contact surface of said driven member is provided with a stud tenon, while the corresponding contact surface of said driving member is provided with a slot mortise so as to form a confinement means for making the axial line of the motor and the load shafts along a straight line.

10. The clutch mechanism as in claim 9, wherein alternatively, said slot mortise is formed on the contact surface of said driven member, while said stud tenon is formed on the contact surface of said driving member.

11. The clutch mechanism as in claim 1, wherein a friction brake is fixed on each of the contact surfaces of said driving member and said driven member.

12. The clutch mechanism as in claim 1, wherein the driving and the driven members are substitutional for each other.

13. A modular ultrasonic brake mechanism comprising:
an AC power control unit including an AC power supply for supplying AC power to a piezoelectric element with electric conductors via a carbon brushes; a control switch for controlling the connection or disconnection between the AC power supply and the carbon brushes; two slip rings for introducing the AC power to said piezoelectric element; two carbon brushes; and a brush holder for connecting the supplied AC power to said slip rings;
a driving member being a ultrasonic vibrator for generating a mechanical vibration, and being able to disconnect the clutching operation between the driving member and a friction brake by a radiation field induced using the mechanical vibration;
a friction brake being a metal block;
a supporting frame unit containing a supporting frame for supporting a bearing precisely along the center line of the mechanism; said bearing for supporting said friction brake by inserting the latter into the former; one end of said friction brake being connected to a rotational terminal of said mechanism; and a spring washer equipped between said supporting frame and said bearing for providing a pre-loaded force;
a pre-loaded force adjustment means installed in the center hole of said supporting frame to couple with the outer-threaded surface of the pre-loaded force adjustment means just passing the center hole of said supporting frame for adjusting the frictional force between the contact surfaces of said driving member and said friction brake; and
a pedestal for mounting said supporting frame unit.

14. The brake mechanism as in claim 13, wherein said ultrasonic vibrator is formed of a pair of adjoining piezoelectric elements, two non-adjoining cylindrical metal blocks, and two slip rings, and the above components are screw engaged one another with a threaded bolt and a nut.

15. The brake mechanism as in claim 13, wherein said driving member is a piezoelectric resonator.

16. The brake mechanism as in claim 15, wherein said piezoelectric resonator is formed of a piezoelectric element, a metal block, and a slip ring.

17. The brake mechanism as in claim 13, wherein said driving member or said friction brake is made of a piezoelectric substance.

18. The brake mechanism as in claim 13, wherein said driving member can serve as a brake means for controlling rotational motion or linear motion

19. The brake mechanism as in claim 13, wherein the driving member and the friction brake are substitutional for each other.
